(19) United States
(12) Patent Application Publication
(10) Pub. No.: US 2015/0295738 A1
(43) Pub. Date: Oct. 15, 2015

(54) COMMUNICATION SYSTEM

(71) Applicants: DENSO CORPORATION, Kariya-city (JP); NIPPON SOKEN, INC., Nishio-city (JP)

(72) Inventors: Hiroyuki MORI, Obu-city (JP); Keiji SHIGEOKA, Nishio-city (JP); Hideki KASHIMA, Kariya-city (JP); Tomohisa KISHIGAMI, Obu-city (JP)

(21) Appl. No.: 14/669,093

(22) Filed: Mar. 26, 2015

(30) Foreign Application Priority Data
Apr. 14, 2014 (JP) 2014-83014

(51) Int. Cl. H04L 25/49; H04B 3/54

(52) U.S. Cl. CPC H04L 25/4902; H04B 3/54

(57) ABSTRACT

Each of nodes in a communication system includes a pull-up circuit connected between a power source and a transmission line and a switching portion connecting and disconnecting the transmission line and a ground line. One of the nodes is a master node, and the others of the nodes are slave nodes. The driver circuits are driven so that the master node constantly outputs the transmission code of logic 1 and the slave node outputting the transmission code of logic 0 extends the width of the low level of the transmission code of logic 1 on the transmission line. The master node further includes a current limiting section limiting an electric current that flows to the transmission line via the pull-up circuit based on at least a signal level of the transmission line.

### CROSS REFERENCE TO RELATED APPLICATIONS

The present application is based on and claims priority to Japanese Patent Application No. 2014-83014 filed on Apr. 14, 2014, the disclosure of which is incorporated herein by reference.

### TECHNICAL FIELD

The present disclosure relates to a communication system that uses a pulse width modulation (PWM) code as a transmission code.

### BACKGROUND

In a communication system mounted in a vehicle, a communication system that uses a PWM code as a transmission code has been known (see, for example, SAE International J1850). In a case where a high level of a signal level on a transmission line is set as recessive and a low level of the signal level on the transmission line is set as dominant, the transmission line is configured so that the signal level on the transmission line becomes dominant when any one of nodes outputs a signal of dominant. In this case, it can be considered that the communication system is configured so that a waveform of the transmission code is determined by superimposing the signals output from the respective nodes.

In other words, a PWM code of a small ratio of the low level is associated with logic 1 and a PWM code of a large ratio of the low level is associated with logic 0, and one of nodes (master node) outputs the PWM code of logic 1 in a bus idle state in which any node does not communicate. A node (slave node) other than the master node outputs such a signal that the transmission code on the transmission line becomes a desired PWM code when superimposed on the PWM code of logic 1 output from the master node.

Specifically, for example, when the slave node outputs the PWM code of logic 1, the PWM code of logic 1 can be actualized by outputting a signal at the high level over the whole period of the code. On the other hand, when the slave node outputs the PWM code of logic 0, the PWM code of logic 0 can be actualized by outputting a signal that rewrites a part of the PWM code of logic 1 output from the master node from the high level to the low level.

In general, a driver circuit of a node is formed using a transistor that connects and disconnects the transmission line and the ground line. In other words, the transistor is turned off when an output signal of the node is set to be recessive, and the transistor is turned on when an output signal of the node is set to be dominant.

Thus, in a case where the PWM code is rewritten to logic 0 by the slave node as described above, an output signal of an driver circuit of the master node is changed from the low level to the high level when an output signal of a driver circuit of the slave node is maintained at the low level. Then, at the moment, electric current flows from the master node to the driver circuit of the slave node that rewrites the code (i.e., the slave node that outputs the signal at the low level), and noise may be generated due to a rapid current change.

### SUMMARY

It is an object of the present disclosure to provide a communication system that uses a PWM code as a transmission code and can restrict generation of noise.

A communication system according to an aspect of the present disclosure uses a pulse width modulation code, in which a width of a low level of logic 1 is narrower than a width of a low level of logic 0, as a transmission code and includes a plurality of nodes. Each of the nodes includes a driver circuit that includes a pull-up circuit connected between a power source and a transmission line and a switching portion connecting and disconnecting the transmission line and a ground line. One of the nodes is a master node, and the others of the nodes are slave nodes. The driver circuits are driven so that the master node constantly outputs the transmission code of logic 1 and the slave node outputting the transmission code of logic 0 extends the width of the low level of the transmission code of logic 1 on the transmission line. The master node further includes a current limiting section that limits an electric current flowing to the transmission line via the pull-up circuit based on at least a signal level of the transmission line.

A rapid current change may occur at beginning and ending of a period in which the master node outputs a signal at the high level and the slave node outputs a signal at the low level, and the period is included in a period in which the signal level of the transmission line is at the low level. Thus, by limiting the electric current that flows to the transmission line via the pull-up circuit in the master node, a current change that causes noise can be restricted.

### BRIEF DESCRIPTION OF THE DRAWINGS

Additional objects and advantages of the present disclosure will be more readily apparent from the following detailed description when taken together with the accompanying drawings. In the drawings:

FIG. 1 is a diagram illustrating an in-vehicle communication system according to a first embodiment;

FIG. 2 is a diagram illustrating a transmission code;

FIG. 3 is a timing diagram illustrating an encoding operation;

FIG. 4 is a circuit diagram illustrating a current limiter according to the first embodiment;

FIG. 5 is a timing diagram illustrating waveforms of a bus voltage, a resistance value of the current limiter, and a bus current;

FIG. 6 is a circuit diagram illustrating a control signal generation circuit according to a second embodiment;

FIG. 7 is a diagram illustrating a mater according to a third embodiment;

FIG. 8 is a circuit diagram illustrating a current limiter according to the third embodiment;

FIG. 9 is a timing diagram illustrating waveforms of a bus voltage, a resistance value of the current limiter, and a bus current;

FIG. 10 is a circuit diagram illustrating a resistance switching circuit according to a modification; and

FIG. 11 is a circuit diagram illustrating a resistance switching circuit according to another modification.

### DETAILED DESCRIPTION

Embodiments of the present disclosure will be described with reference to the drawings.

### First Embodiment

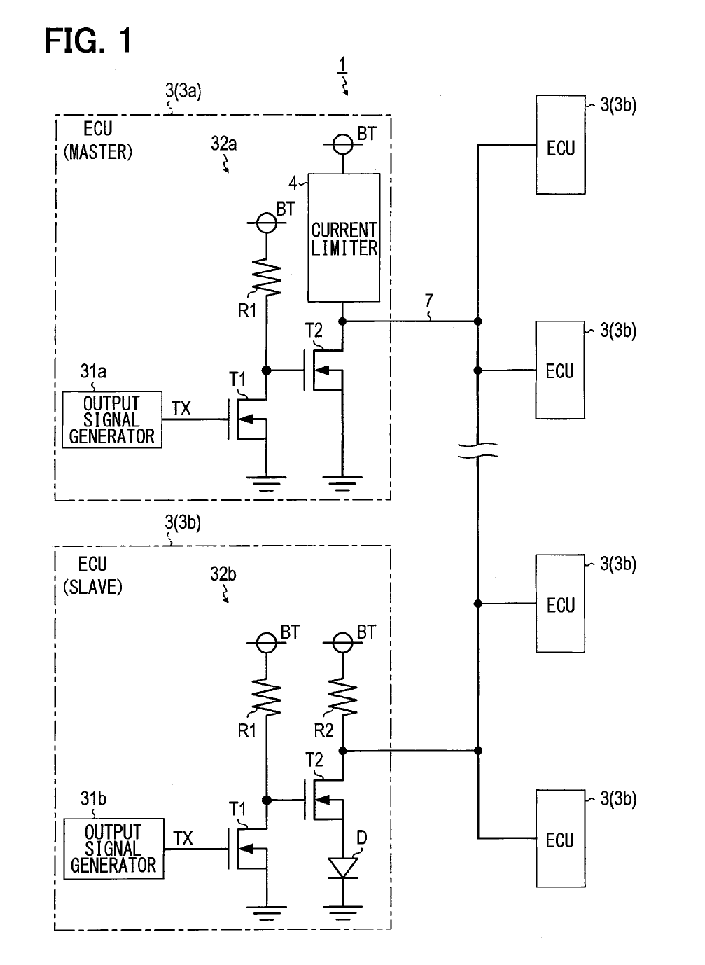

In an in-vehicle communication system 1 according to a first embodiment of the present disclosure, as illustrated in FIG. 1, a plurality of electronic control units (ECUs) mounted in a vehicle are connected via a bus-state transmission line 7 so as to communicate with each other. Hereinafter, each of the ECUs is referred to as a node 3.

The transmission line 7 is configured so that a signal level on the transmission line 7 becomes a low level when a signal at a high level (recessive) and a signal at a low level (dominant) are concurrently output from the different nodes 3 and actualizes a bus arbitration using the above-described function.

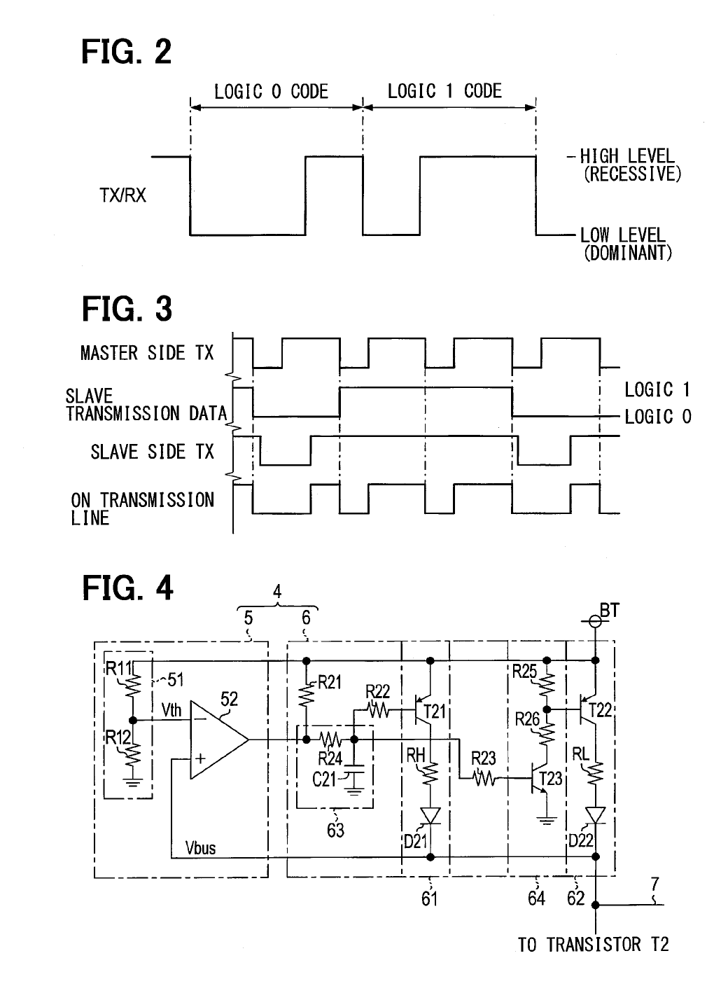

As illustrated in FIG. 2, the transmission line 7 uses, as a transmission code, a pulse width modulation (PWM) code in which a signal level changes from a high level to a low level at a boundary of bits and the signal level changes from the low level to the high level in the middle of the bit. The transmission code expresses signals of two values (logic 0 and logic 1) with two codes having different duty ratios. Hereinafter, a signal in which the ratio of the low level is larger (i.e., the duration time of the low level is longer) is referred to as a logic 0 code, and a signal in which the ratio of the low level is smaller (i.e., the duration time of the low level is shorter) is referred to as a logic 1 code.

Specifically, in the logic 0 code, the signal is at the low level for ⅔ period of 1 bit and the signal is at the high level for ⅓ period of 1 bit. In the logic 1 code, the signal is at the low level for ⅓ period of 1 bit and the signal is at the high level for ⅔ period of 1 bit. Thus, when the logic 0 code and the logic 1 code collide with each other on the transmission line 7, the logic 0 code is granted by arbitration. In other words, a waveform of the transmission code on the transmission line 7 is obtained by superimposing waveforms of the signals output from the respective nodes 3.

One of the nodes 3 is a master node 3a (hereinafter, simply referred to as the master 3a) that controls the whole communication, and the others are slave nodes 3b (hereinafter, simply referred to as the slaves 3b). The master 3a and the slaves 3b actualize at least a master slave communication in so-called polling method.

Each of the nodes 3 includes a signal processor, a transceiver, and a power supply circuit. The signal processor executes various processing assigned to the own node 3 based on information obtained by communication with the other nodes 3 via the transmission line 7. The transceiver encodes a transmission data from the signal processor and outputs the encoded data to the transmission line 7. In addition, the transceiver receives and decodes a signal from the transmission line 7 and supplies the decoded received data to the signal processor. The power supply circuit receives power from an in-vehicle battery (battery voltage BT) and generates a control power source (control voltage Vc) for driving, for example, the signal processor.

In FIG. 1, output signal generators 31a, 31b and driver circuits 32a, 32b are illustrated, and receiver circuits and received signal processors that process received signals received at the receiver circuits are not illustrated. The driver circuits 32a, 32b constitute a part of the transceivers and switch the signal level of the transmission line 7 based on transmission signals TX supplied from the output signal generators 31a, 31b. The output signal generators 31a, 31b constitute the signal processors and a part of the transceivers and generate the transmission signals encoded into the PWM codes.

Because the master 3a and the slaves 3b have similar configurations, the configuration of the master 3a is illustrated in FIG. 1, and regarding the configurations of the slaves 3b, only points different from the master 3a will be described.

The output signal generators 31a, 31b generate the encoded transmission signals TX supplied to the driver circuits 32a, 32b. However, the output signal generator 31a in the master 3a and the output signal generator 31b in the slave 3b generate the transmission signals TX different from each other.

When the transmission data before encoding is logic 1, the output signal generator 31a in the master 3a generates the transmission signal TX that is the logic 1 code. When the transmission data before encoding is logic 0, the output signal generator 31a in the master 3a generates the transmission signal TX that is the logic 0 code. In addition, even when the data is not output, the output signal generator 31a in the master 3a constantly outputs the logic 1 code (hereinafter, referred to as a master transmission clock) that functions as a clock signal for synchronizing operations of the respective nodes 3.

On the other hand, as illustrated in FIG. 3, when the transmission data before encoding is logic 1, the output signal generator 31b in the slave 3b generates the high level signal as the transmission signal TX over the whole period of the code. When the transmission data before encoding is logic 0, the output signal generator 31b in the slave 3b generates a signal that changes to the low level at a time delayed from a start time of the code and changes to the high level at a time of a rising edge of the logic 0 code, as the transmission signal TX. The transmission signal TX from slave 3b having the above-described waveform has the waveform of the logic 1 code or the logic 0 code by being superimposed on the master transmission clock on the transmission line 7.

The driver circuit 32a in the master 3a includes, as illustrated in FIG. 1, transistors T1, T2, a resistor R1, and a current limiter 4 and operates with the battery voltage BT as the power source. When the transmission signal TX is at the high level, the transistor T1 is turned on and the transistor T2 is turned off so that the driver circuit 32a outputs a signal at the high level to the transmission line 7. When the transmission signal TX is at the low level, the transistor T1 is turned off and the transistor T2 is turned on so that the driver circuit 32a outputs a signal at the low level to the transmission line 7.

The driver circuit 32b in the slave 3b is different from the driver circuit 32a in that the driver circuit 32b includes a resistor R2 instead of the current limiter 4 and includes a diode D connected in series with the transistor R2 between the transmission line 7 and the ground. Due to the diode D, the low level output from the slave 3b is higher than the low level output from the master 3a by a voltage corresponding to a voltage drop of the diode D. Hereinafter, the low level output from the master 3a is referred to as a master low level VLm, and the low level output from the slave 3b is referred to as a slave low level VLs.

The current limiter 4 in the master 3a includes, as illustrated in FIG. 4, a control signal generation circuit 5 and a resistance switching circuit 6 and operates with the battery voltage BT as the power source.

The control signal generation circuit 5 includes a voltage dividing circuit 51 and a comparator 52. The voltage dividing circuit 51 includes a pair of resistors R11, R12 connected in series and outputs a threshold voltage Vth obtained by dividing the battery voltage BT. The threshold voltage Vth is set to be, for example, ½ of the battery voltage BT. The comparator 52 includes an operational amplifier in which a non-inverting input terminal is applied with the signal level of the transmission line 7 (hereinafter, referred to as a bus voltage Vbus) and an inverting input terminal is applied with the threshold voltage Vth. The comparator 52 outputs a control signal C that becomes the high level when the bus voltage Vbus is higher than the threshold voltage Vth and becomes the low level when the bus voltage Vbus is equal to or lower than the threshold voltage Vth.

The resistance switching circuit 6 includes a high resistance addition circuit 61, a low resistance addition circuit 62, a filter circuit 63, and an inverting circuit 64. An input terminal of the filter circuit 63 is connected with a pull-up resistor R21 that pulls up the high level of the control signal C to the battery voltage BT. An output signal of the filter circuit 63 is output to the high resistance addition circuit 61 and the inverting circuit 64 via resistors R22, R23, respectively, and an output signal of the inverting circuit 64 is output to the low resistance addition circuit 62.

The high resistance addition circuit 61 includes a high resistor RH for pull-up. One end of the high resistor RH is connected to the transmission line 7 via a diode D21 for preventing a reverse current. The other end of the high resistor RH is connected to the power source (the battery voltage BT) via a transistor T21. A base of the transistor T21 becomes an input terminal of the high resistance addition circuit 61. The low resistance addition circuit 62 includes a low resistor RL, a diode D22, and a transistor R22, which are connected in a manner similar to the high resistance addition circuit 61. The low resistor RL has a resistance value lower than the high resistor RH. The filter circuit 63 is a known low pass filter including a resistor 24 and a capacitor C21 and removes a high frequency noise included in the control signal C. The inverting circuit 64 includes a pair of resistors R25, R26 that constitute a voltage dividing circuit. One end of the voltage dividing circuit is connected to the power source (the battery voltage BT) and the other end of the voltage dividing circuit is connected to the ground via a transistor T23. A base of the transistor T23 becomes an input terminal of the inverting circuit 64, and a connection point of the resistors R25, R26 becomes an output terminal of the inverting circuit 64.

In other words, in the resistance switching circuit 6, when the control signal C generated by the control signal generation circuit 5 is the low level (i.e., the bus voltage Vbus is at the low level), the transistor T21 in the high resistance addition circuit 61 is turned on so that the high resistor RH functions as a pull-up resistor of the transmission line 7. When the control signal C is at the high level (i.e., the bus voltage Vbus is at the high level), the transistor T22 in the low resistance addition circuit 62 is turned on so that the low resistor RL functions as a pull-up resistor of the transmission line 7.

Next, an operation in a case where the master 3a outputs the logic 1 code and one of the slaves 3b outputs the logic 0 code will be described.

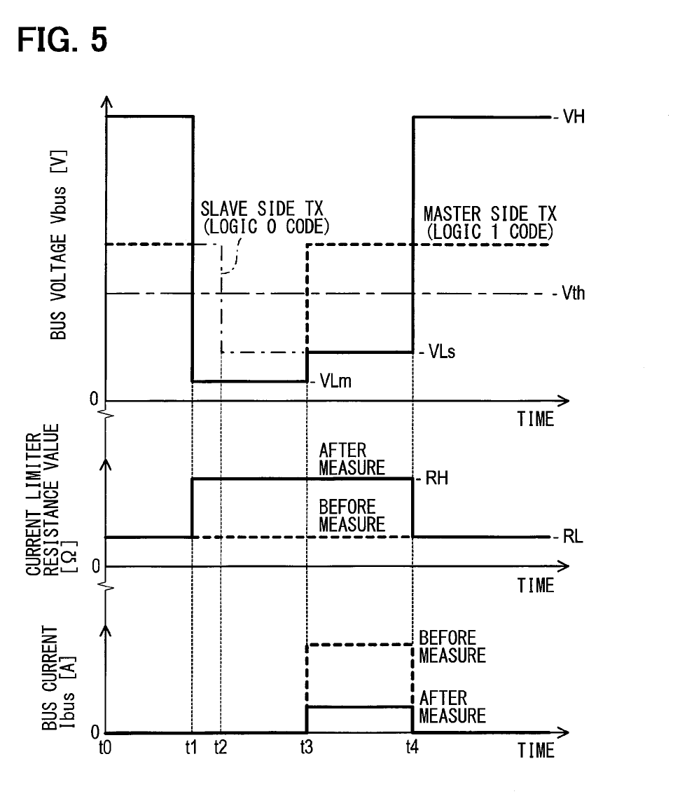

As illustrated in FIG. 5, during a period in which both of the output signals of the master 3a and the slave 3b are at the high level (time t0 to t1), the bus voltages Vbus is at the high level. At the time, the bus voltage Vbus is higher than the threshold voltage Vth. Thus, the pull-up resistor of the current limiter 4 in the master 3a is set to the low resistor RL.

When the master 3a starts to output the low level of the logic 1 code (time t1), the output signal of the master 3a is at the low level and the output signal of the slave 3b is at the high level. Thus, the bus voltage Vbus changes from the high level VH to the master low level VLm. At the time, the bus voltage Vbus is lower than the threshold voltage Vth. Thus, the pull-up resistor of the current limiter 4 is switched to the high resistor RH.

When the slave 3b starts to output the low level of the logic 0 code (time t2), both of the output signals of the master 3a and the slave 3b become the low level. However, because the master low level VLm is lower than the slave low level VLs, the bus voltage Vbus is maintained at the master low level VLm. Thus, electric current supplied via the current limiter 4 in the master 3a flows to the transistor T2 without flowing to the transmission line 7. At the time, the pull-up resistor of the current limiter 4 is the high resistor RH. Thus, the electric current that flows to the transistor T2 is restricted.

When the master 3a starts to output the high level of the logic 1 code (time t3), the output signal of the master 3a is at the high level and the output signal of the slave 3b is at the low level. Accordingly, the bus voltage Vbus increases from the master low level VLm to the slave low level VLs. At the time, because the electric current supplied via the current limiter 4 in the master 3a flows to the transmission line 7, the bus current Ibus flows. However, because the pull-up resistor of the current limiter 4 is the high resistor RH, the bus current Ibus is restricted compared with a case (before measure) where the pull-up resistor is not switched.

When the slave 3b starts to output the high level of the logic 0 code (time t4), both of the output signals of the master 3a and the slave 3b become the high level. Accordingly, the bus voltage Vbus changes from the slave low level VLs to the high level VH. At the time, the bus voltage Vbus becomes higher than the threshold voltage Vth. Thus, the pull-up resistor of the current limiter 4 in the master 3a is switched to the low resistor RL.

In FIG. 5, a falling edge and a rising edge of the bus voltage Vbus are schematically illustrated so that a fall time and a rise time are zero. However, actually, the waveform of the falling edge has an inclination according to the resistance value of the pull-up resistor. Specifically, the inclination of the edge becomes gentle when the bus voltage is equal to or lower than the threshold voltage Vth (i.e., the pull-up resistor is the high resistor RH) compared with when the bus voltage Vbus is higher than the threshold voltage Vth (i.e., the pull-up resistor is the low resistor RL).

As described above, in the in-vehicle communication system 1, the pull-up resistor in the driver circuit 32a in the master 3a is set to the high resistor TH when the signal level of the transmission line 7 is at the low level or dominant (Vbus≦Vth), and is set to the low resistor RL when the signal level of the transmission line 7 is at the high level or recessive (Vbus>Vth). Accordingly, compared with a conventional device that does not switch a resistance value of a pull-up resistor, the bus current Ibus that flows from the master 3a to the slave 3b can be restricted when the output signal of the slave 3b is at the low level and the output signal of the master 3a is at the high level, and thereby a current change at beginning and ending of the flow of the bus current Ibus can be restricted. As a result, a generation of noise due to the current change of the bus current Ibus can be restricted.

Furthermore, in the in-vehicle communication system 1, the slave low level VLs is set to be higher than the master low level VLm by providing the diode D in the driver circuit 32b in the slave 3b. Thus, compared with a case where the diode D is not provided, the bus current Ibus that flows from the master 3a to the slave 3b can be more restricted.

### Second Embodiment

Because fundamental configurations of an in-vehicle communication system 1 according to a second embodiment is similar to those of the first embodiment, a description about common configurations will be omitted, and different points are mainly described below.

In the above-described first embodiment, the control signal generation circuit 5 uses a fixed value as the threshold voltage Vth for comparison with the bus voltage Vbus. On the other hand, in the present embodiment, different threshold voltages are used at a falling edge and a rising edge of the waveform of the bus voltage Vbus.

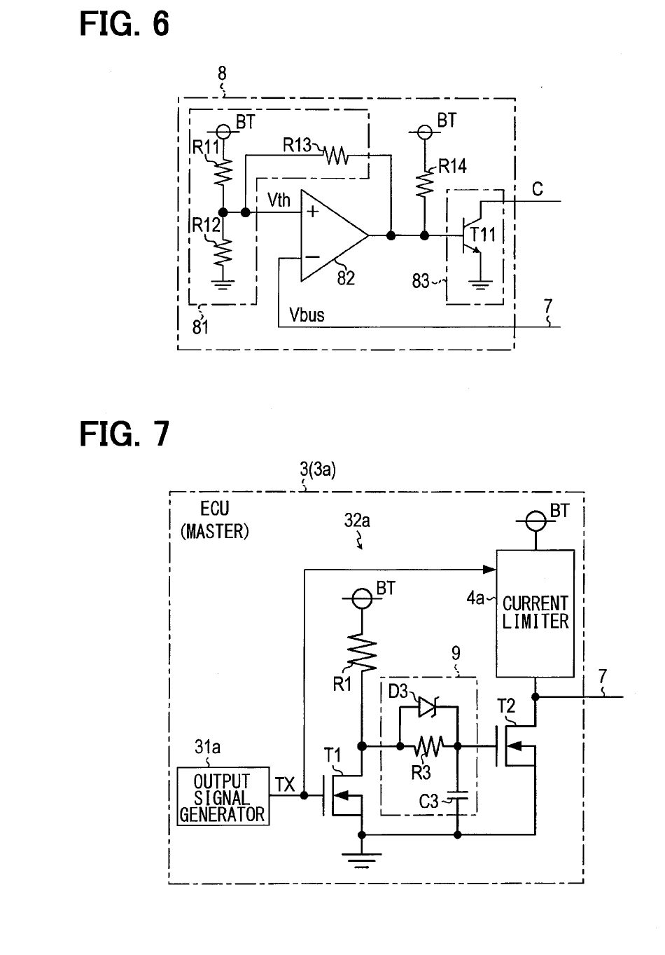

In the present embodiment, the current limiter 4 includes a control signal generation circuit 8 instead of the control signal generation circuit 5. The control signal generation circuit 8 includes, as illustrated in FIG. 6, a variable voltage dividing circuit 81, a comparator 82, and an inverting circuit 83.

The comparator 82 includes an operational amplifier in which an inverting input terminal is applied with the bus voltage Vbus and a non-inverting input terminal is applied with the threshold voltage Vth generated by the variable voltage dividing circuit 81. An output terminal of the comparator 82 is connected to an input terminal of the inverting circuit 83 and is pulled-up to the battery voltage BT by a resistor R14.

The inverting circuit 83 includes a transistor T11 in which an emitter is connected to the ground. A base of the transistor T11 becomes an input terminal that receives an output signal from the comparator 82, and a collector of the transistor T11 becomes an output terminal that outputs the control signal C.

The variable voltage dividing circuit 81 includes a pair of resistors R11, R12 and a resistor R13. The resistors R11, R12 are connected in series between the battery voltage BT and the ground, and a common connection terminal is connected to the non-inverting input terminal of the operational amplifier. The resistor R13 is connected between the non-inverting input terminal and an output terminal of the operational amplifier.

In the control signal generation circuit 8 configured as described above, when the bus voltage Vbus is at the high level, because the output signal of the comparator 82 becomes the low level, the resistor R13 is connected in parallel with the resistor R12. On the other hand, when the bus voltage Vbus is at the low level, because the output signal of the comparator 82 becomes the high level, the resistor R13 is connected in parallel with the resistor R11. Accordingly, when the bus voltage Vbus is at the low level, the threshold voltage Vth generated by the resistor R11-R13 included in the variable voltage dividing circuit 81 becomes higher than when the bus voltage Vbus is at the high level. In other words, a threshold voltage Vth#U that is used for the determination of whether the bus voltage changes from the low level to the high level is higher than a threshold voltage Vth#D that is used for the determination of whether the bus voltage changes from the high level to the low level. For example, the threshold voltage Vth#D is set to about ½ of the battery voltage in a manner similar to the first embodiment, and the threshold voltage Vth#U is set to about ⅘ of the battery voltage BT.

According to the above-described configuration, the threshold voltage Vth used for the comparison with the bus voltage Vbus has hysteresis and the pull-up resistor of the driver circuit 32a in the master 3a changes from the high resistor RH to the low resistor RL after the bus voltage Vbus becomes a sufficiently high value. Accordingly, an increase in the bus voltage Ibus generated when the pull-up resistor is changed from the high resistor RH to the low resistor RL can be restricted, and eventually a generation of noise can be restricted.

### Third Embodiment

Because fundamental configurations of an in-vehicle communication system 1 according to a third embodiment is similar to those of the first embodiment, a description about common configurations will be omitted, and different points are mainly described below.

In the first embodiment, the current limiter 4 switches the resistance value of the pull-up resistor in accordance with the bus voltage Vbus. The present embodiment is different from the first embodiment in that the resistance value of the pull-up resistor is switched in accordance with the bus voltage Vbus and the transmission signal TX output from the output signal generator 31a, and each of the nodes 3 has a configuration for shaping a waveform of a signal supplied to a gate of a transistor T2.

As illustrated in FIG. 7, the driver circuit 32a in the master 3a includes transistors T1, R2, a resistor R1, a current limiter 4a, and a waveform shaping circuit 9.

The waveform shaping circuit 9 includes a zener diode D3, a resistor R3, and a capacitor C3, and is connected between a drain of the transistor T1 and a base of the transistor T2. The zener diode D3 and the resistor R3 are connected in parallel between the transistors T1, T2. The capacitor C3 is inserted between a gate of the transistor T2 and the ground.

When the transmission signal TX is at the low level, the transistor T2 is turned off, and the capacitor C3 is quickly charged to the battery voltage BT via the zener diode D3. In contrast, when the transmission signal TX is at the high level, the transistor T2 is turned on, and electric charges stored in the capacitor C3 are discharged with a fixed current that depends on a zener voltage of the zener diode D3 and a resistance value of the resistor R3. Accordingly, a conductive state of the transistor T2 gently changes from an on state to an off state. In other words, the conductive state of the transistor T2 quickly changes at the falling edge at which the transmission signal TX changes from the high level to the low level, and gently changes at the rising edge at which the transmission signal TX changes from the low level to the high level compared with the falling edge. Although only master 3a is illustrated in FIG. 7, the waveform shaping circuit 9 is also added to each of the slaves 3b.

The current limiter 4a receives the transmission signal TX differently from the current limiter 4 in the first embodiment. The current limiter 4a includes a control signal generation circuit 10 and a resistance switching circuit 6. Because the resistance switching circuit 6 is similar to the resistance switching circuit 6 described in the first embodiment, only the control signal generation circuit 10 will be described below.

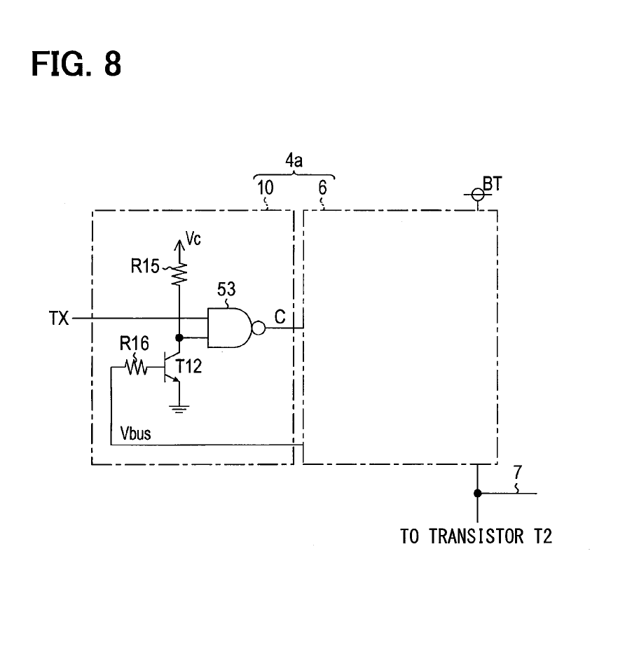

The control signal generation circuit 10 includes, as illustrated in FIG. 8, a transistor T12, resistors R15, R16, and a NAND circuit 53, and operates with power supply from the control power source (a voltage Vc).

A collector of the transistor T12 is connected to the control power source via the resistor R15, and an emitter of the transistor T12 is connected to the ground. A base of the transistor T12 is applied with the bus voltage Vbus via the resistor. One input terminal of the NAND circuit 53 is applied with the transmission signal TX, and the other input terminal is applied with a collector output of the transistor T12. The NAND circuit 53 outputs the control signal C. The control signal C becomes the low level when the transmission signal TX is at the high level and the bus voltage Vbus is at the low level, and becomes the high level in the other cases.

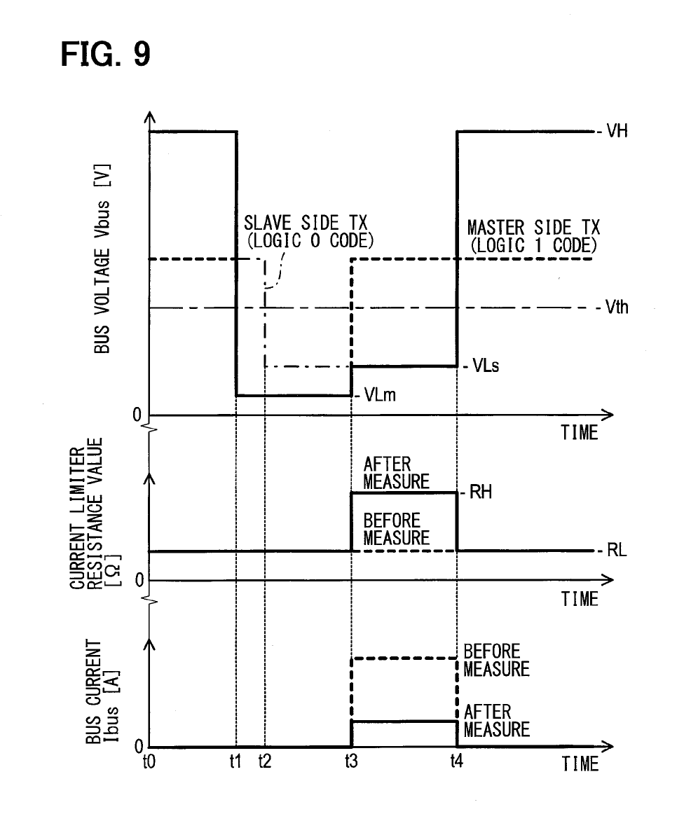

According to the above-described configuration, as illustrated in FIG. 9, the pull-up resistor of the driver circuit 32a in the master 3a is switched from the low resistor RL to the high resistor RH only for a period from time t3 to time t4 during which electric current flows from the master 3a to the slave 3b. Thus, a period during which the pull-up resistor is set to the high resistor RH can be limited to the minimum necessary. As a result, a deterioration of noise resistance associated with the use of the high resistor RH can be restricted to the minimum necessary.

The waveform shaping circuit 9 in the master 3a restricts a rapid change of the bus voltage waveform at the rising edge at time t3, and the waveform shaping circuit 9 in the slave 3b restricts a rapid change of the bus voltage waveform at the rising edge at time t4. Thus, the generation of noise at the edges can be effectively restricted.

### Other Embodiments

Although the present disclosure has been fully described in connection with the exemplary embodiments thereof with reference to the accompanying drawings, it is to be noted that various changes and modifications will become apparent to those skilled in the art.

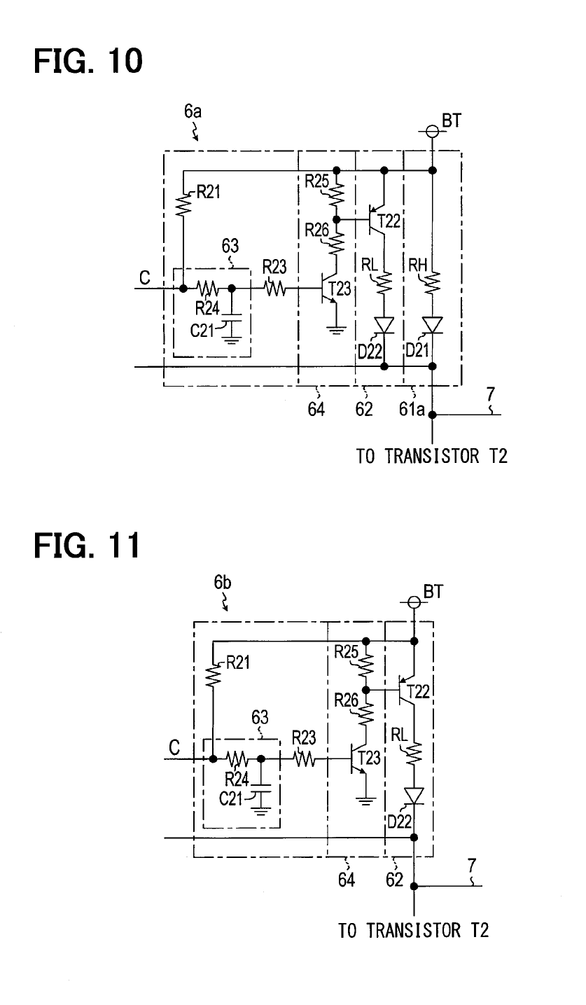

In each of the above-described embodiments, the resistance switching circuit 6 connects one of the high resistor RH and the low resistor RL to the transmission line 7 based on the control signal C. However, the configuration of the resistance switching circuit 6 is not limited to the above-described example. For example, as a resistance switching circuit 6a illustrated in FIG. 10, the high resistance addition circuit 61 in the resistance switching circuit 6 illustrated in FIG. 4 may be replaced by a high resistance addition circuit 61a in which the transistor T21 is omitted and the high resistor RH is constantly connected to the transmission line 7, the resistor R22 may be omitted, and only the low resistor RL may be connected or disconnected based on the control signal C. Alternatively, as a resistance switching circuit 6b illustrated in FIG. 11, the high resistance addition circuit 61a may be omitted from the resistance switching circuit 6a. In the present case, when the low resistor RL is disconnected, the pull-up resistor becomes a high impedance. In addition, in the present case, instead of turning off the transistor T22, an on-resistance of the transistor T22 may be controlled to be large.

In each of the above-described embodiments, the resistance value of the pull-up resistor of the driver circuit 32a in the master 3a is controlled between two stages, that is, the low resistor RL and the high resistor RH. However, the resistance value of the pull-up resistor may be controlled among three or more stages.

Components in the present disclosure are conceptual, and are not limited to those in the above-described embodiments. For example, a function of one component may be dispersed to multiple components, or a function of multiple components may be integrated to one component. At least a part of the configuration in each of the above-described embodiments may be replaced by a known configuration having similar function. At least a part of the configuration of one of the above-described embodiments may be added to or replaced by the configuration of another one of the above-described embodiments.

Other than the above-described communication systems, the present disclosure can be actualized in various forms, such as a node included in the communication systems, and a program for making a computer function as the node.

What is claimed is:

1. A communication system using a pulse width modulation code, in which a width of a low level of logic 1 is narrower than a width of a low level of logic 0, as a transmission code and comprising a plurality of nodes each including a driver circuit that includes a pull-up circuit connected between a power source and a transmission line and a switching portion connecting and disconnecting the transmission line and a ground line, one of the nodes being a master node, the others of the nodes being slave nodes, the driver circuits being driven so that the master node constantly outputs the transmission code of logic 1 and the slave node outputting the transmission code of logic 0 extends the width of the low level of the transmission code of logic 1 on the transmission line, wherein
the master node further includes a current limiting section that limits an electric current flowing to the transmission line via the pull-up circuit based on at least a signal level of the transmission line.

2. The communication system according to claim 1, wherein
the current limiting section includes a plurality of resistors, and a switching circuit that switches a connection state of one of the resistors, and increases a resistance value of the pull-up circuit when the signal level of the transmission line is at the low level.

3. The communication system according to claim 1, wherein
the current limiting section includes a plurality of resistors and a switching circuit that switches a connection state of one of the resistors, and increases a resistance value of the pull-up circuit when the signal level of the transmission line is at the low level and the driver circuit is driven so that an output signal of the driver circuit becomes the high level.

4. The communication system according to claim 3, wherein
the master node further includes a waveform shaping section that restricts a change speed of a signal level when an output signal of the driver circuit changes from the low level to the high level.

5. The communication system according to claim 1, wherein
each of the slave nodes further includes a waveform shaping section that restricts a change speed of a signal level when an output signal of the driver circuit changes from the low level to the high level.

6. The communication system according to claim 1, wherein
the current limiting section uses a threshold value having hysteresis for determining the signal level of the transmission line, and
the threshold value used for determining a change from the high level to the low level and the threshold value used for determining a change from the low level to the high level are set to be different values.

7. The communication system according to claim 1, wherein
the current limiting section controls the resistance value of the pull-up circuit among three or more stages.

8. The communication system according to claim 1, wherein
each of the slave nodes includes a level shifting section that sets the signal level of the transmission line when the switching portion included in the driver circuit in each of the slave nodes is on to be higher than the signal level of the transmission line when only the switching portion included in the driver circuit in the master node is on.
